(19) United States
(12) Patent Application Publication
(10) Pub. No.: US 2019/0361847 A1
(43) Pub. Date: Nov. 28, 2019

(54) Spatial Linking Visual Navigation System and Method of Using the Same

(71) Applicant: Stephen C. Thomson, Jersey City, NJ (US)

(72) Inventor: Stephen C. Thomson, Jersey City, NJ (US)

(21) Appl. No.: 16/418,499

(22) Filed: May 21, 2019

Related U.S. Application Data
(60) Provisional application No. 62/675,379, filed on May 23, 2018.

(51) Int. Cl. G06F 16/16; G06F 16/11; H04L 29/06; G06F 16/188; H04L 29/08

(52) U.S. Cl. CPC G06F 16/168; G06F 16/116; G06F 16/122; G06F 16/196; H04L 67/125; H04L 63/083

(57) ABSTRACT

A spatial linking visual navigation system interfacing with multiple data sources to create a layered image includes a display and interface apparatus. The interface apparatus has a content receiver configured to acquire a first primary file from any one of the data sources where the primary file has at least an image of one object thereon. An overlay generator generates a transparent layer to be overlaid over the primary file which spatially corresponds to the primary file. A link generator generates an icon on the transparent layer over the at least one object such that the icon represents a link to data contained in the data sources related to the object in the primary file. The overlay generator, without modifying the primary file, prepares the layered image, which is a combined view of the primary file, the transparent layer, and icons on the transparent layer.

### TECHNICAL FIELD

The present invention is related to a file or document navigation tool and more specifically to a visual navigation tool that organizes a collection of information, files, and/or documents by spatially linking them together. The present invention is also related to a graphical user interface of a visual navigation tool which displays spatially-linked information, files, and/or documents.

### BACKGROUND

In the field of data management, particularly in larger corporations, it is common for a number of legacy data bases and document repositories to be maintained, each of which operates using different architectures. Furthermore, in the case of engineering drawings, maps or other similar drawings used by any organization, the basic image files are often non-intelligent raster format drawings or are otherwise not in a format suitable for easy modification.

However, there is a need to integrate or consolidate disparate files—such as one-line diagrams, maps, drawings, image files, text files, sensor information, GPS data, media files, video files, word document files, presentation files, spreadsheet files, audio files, internet-related files, etc.—into a single file so that once a first file is retrieved, other files corresponding to objects on that first file can also be easily retrieved. For example, in the case of an engineering drawing, there can be hundreds if not thousands of objects on a single image, each of which has corresponding data saved in the system, such as additional sub-images, text files, etc. However, in many cases, the first image file cannot be modified to add links to these related data files.

Traditional data integration solutions often require that the current software applications be replaced with already integrated alternatives as in the case of Enterprise Resource Planning (ERP) solutions. Alternatively, very costly, time consuming integration code must be written to get separate application software and associated data to work together.

Standard Computer Aided Design (CAD) and Geographic Information Systems (GIS) typically require a vector rather than a raster format for drawings and maps to be used. Further, prior art systems require the user to work in the native file format of the image document that is being overlaid.

Additionally, prior art systems do not provide effective security or control over users' access to files or documents, some of which may contain sensitive or classified information which should only be viewed by a limited number of users privy to such information. Prior art systems also lack the capability of functioning or connecting with multiple networks of sensors (Internet of Things), which may be managed by different entities (e.g., companies, parties, etc.).

Thus, there exists a need in the art for a visual navigation tool which has the capacity to address the above problems.

### SUMMARY

The needs set forth herein as well as further and other needs and advantages are addressed by the present teachings, which illustrate solutions and advantages described below.

It is an object of the present teachings to remedy the above drawbacks and issues associated with conventional document navigation tools, systems, and methods.

It is an object of the present teachings to provide a system which provides simple, intuitive, flexible, yet powerful visual navigation to needed documents in a few user selections or inputs (e.g., mouse clicks, touch gestures, etc.). For example, the system enables a user to locate a needed document within five or less user selections/inputs. In another example, the system enables a user to locate a needed document within three or less user selections/inputs.

It is an object of the present teachings to provide a visual navigation system that provides multiple navigation paths between information, files, and/or documents which any user can visually follow to locate a needed document. The visual navigation system should provide a means for even a beginner or novice user of the system to easily and quickly find a needed document. Herein, the terms “document” and “documents” may refer to information, file(s), document(s), or any combination thereof.

It is an object of the present teachings to provide a visual navigation system which helps organize and manage information, files, and/or documents from multiple disparate sources in a coherent, logical fashion, even when the disparate sources are owned and controlled by different entities.

It is an object of the present teachings to provide a document navigation system that augments traditional document management systems, without requiring enterprise-wide legacy systems to be abandoned.

It is an object of the present teachings to provide a visual navigation system which monitors and controls users' access to information, files, and/or documents. The system should provide a layer or multiple layers of security to ensure sensitive information is accessed only by authorized users.

It is an object of the present teachings to provide a document navigation system that retrieves information or data from a sensor present in an Internet of Things network.

These and other objects of the present teachings are achieved by providing a system and method for integrating disparate information sources in the form of documents, data or application software and linking them to icon locations on a transparent digital layer that overlays a primary image document, where the transparent layer and links are separate from and not embedded within the primary document. Most image document formats are supported, whether they are raster, vector or other basic non-coded images such as one-line diagrams, drawings, maps, text, spreadsheets, graphs, charts, photographs, diagrams, 2D and 3D models (e.g., BIM models) or schematics. The transparent digital layer is related to the underlying primary document image by either a local or global coordinate system. The link icon locations and relationships are managed and stored in a separate system database.

The present teachings provide a system and method for integrating a plurality of disparate data sources, each data source having a plurality of documents relating to built environments (e.g., infrastructure, facilities, man-made environments) and/or natural environments. The system includes at least: a display, an interface apparatus, and a security control unit. The display is configured to receive user input, which includes a user credential (e.g., login name and password, security token) and a selection of a primary file that contains a plurality of objects, each object relating to a component of a built environment or a feature of a natural environment. The interface apparatus is configured to communicate with the display and the data sources. The interface apparatus has a content receiver configured to retrieve data from the data sources, and an overlay generator configured to generate a digital overlay document when the interface apparatus receives the selection of the primary file from the display. The digital overlay document comprises a transparent layer. A link generator in the interface apparatus is configured to generate a plurality of icons and insert the icons on the transparent layer of the digital overlay document, each icon linking to one or more documents which are contained in at least one of the data sources and related to one of the plurality of objects. The overlay generator is configured to, without modifying the primary file, superimpose the digital overlay document over the primary file and spatially register the digital overlay document to the primary file so that each icon superimposes over said one of the plurality of objects relating to the one or more documents that the icon links to, and so that the digital overlay document is separate from the primary file. The security control unit is configured to evaluate the user credential, in response to a subsequent selection of one of the icons by the user, to determine if the user is authorized to view the one or more documents which the user-selected icon links to. Upon the security control unit confirming authorization, the display subsequently presents the one or more documents which the user-selected icon links to.

The present teachings also provide a system and method for integrating a plurality of disparate data sources, each data source having a plurality of documents relating to built environments (e.g., infrastructure, facilities, man-made environments) and/or natural environments, the system comprising at least: a display and an interface apparatus. The interface apparatus is configured to communicate with the display and the data sources. The interface apparatus has: a content receiver configured to retrieve data from the data sources; an overlay generator configured to generate a digital overlay document when the interface apparatus receives the selection of the primary file from the display, the digital overlay document comprising a transparent layer; and a link generator configured to generate a plurality of data icons and insert the data icons on the transparent layer of the digital overlay document, each data icon linking to one or more documents which are contained in at least one of the data sources and related to one of the plurality of objects. The link generator is also configured to generate a plurality of sensor icons and insert the sensor icons on the transparent layer of the digital overlay document, each sensor icon linking to a sensor (which may be part of a network of sensors, such as Internet of Things) that provides data about one of the plurality of objects. The overlay generator is configured to, without modifying the primary file, superimpose the digital overlay document over the primary file and spatially register the digital overlay document to the primary file so that each data icon superimposes over said one of the plurality of objects relating to the one or more documents that the data icon links to, and so that each sensor icon superimposes over said one of the plurality of objects about which the sensor provides data. The digital overlay document is separate from the primary file. If one of the data icons is selected, the display presents the one or more documents which the user-selected data icon links to. If one of the sensor icons is selected, the display presents the data which the user-selected sensor icon links to.

Transparent overlays with the icons placed on them enables for easy updates of SLM (spatial linking methodology) icons when the underlying document(s) is modified from one release to the next. A user can slide the icon overlay over the new release of the drawing or document and can make adjustments to the icons just where there are changes in the new release.

Other features and aspects of the present invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIG. 1 is a block diagram of a spatial linking visual navigation system according to the present teachings;

FIG. 2 is a block diagram of the spatial linking visual navigation system of FIG. 1 applied in an exemplary application;

FIG. 3 is a block diagram of the spatial linking visual navigation system of FIG. 1 with additional or alternative features;

FIG. 4 is a block diagram of the spatial linking visual navigation system of FIG. 1 with additional or alternative features;

FIG. 5 is a block diagram of a spatial linking visual navigation system according to the present teachings;

FIG. 6 is a flow chart showing the generation of a layered image using the system of FIG. 1, in accordance with the present teachings;

FIGS. 7A-7C are diagrams of a primary image, transparent layer and layered image generated by the system of FIG. 1, in accordance with the present teachings;

FIG. 8 is a subroutine flow chart for automated link generation from FIG. 6, in accordance with the present teachings;

FIG. 9 is a screen shot of a primary file (e.g., image) and links generated by the system of FIG. 1, in accordance with the present teachings;

FIG. 10 is a screen shot of a primary file (e.g., image) and links generated by the system from FIG. 9, in accordance with the present teachings;

FIG. 11 is a screen shot of a primary file (e.g., image) and links generated by the system from FIG. 10, in accordance with the present teachings;

FIG. 12 is a screen shot of a links icon menu generated by the system from FIG. 11, in accordance with the present teachings;

FIG. 13 is a screen shot of a primary file (e.g., image) and links generated by the system from FIG. 11, in accordance with the present teachings; and

FIG. 14 is a close up screen shot of a primary file (e.g., image) and links generated by the system from FIG. 13, in accordance with the present teachings.

### DETAILED DESCRIPTION

The present teachings are described more fully hereinafter with reference to the accompanying drawings. The following description illustrate the present teachings by way of example, not by way of limitation of the principles of the present teachings.

The present teachings have been described in language more or less specific as to structural features. It is to be understood, however, that the present teachings are not limited to the specific features shown and described, since the devices herein disclosed comprise preferred forms of putting the present teachings into effect.

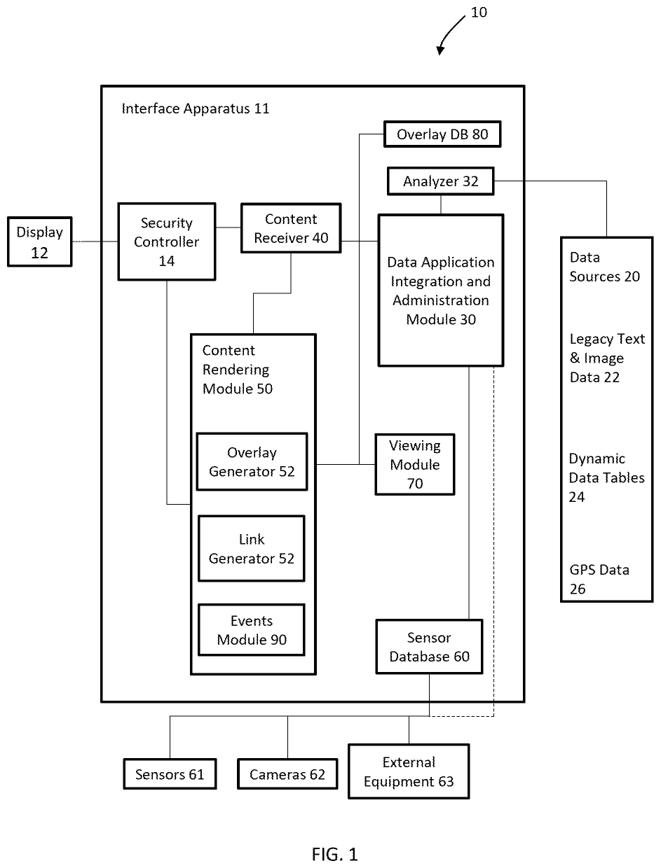

Referring to FIG. 1, a spatial linking visual navigation system 10 is shown. The system 10 is designed to integrate a plurality of disparate data sources 20. As discussed in more detail below, system 10 provides for a user to retrieve a primary image, such as a one-line diagram, map, chart, image, blueprint, or other spatial representation from data sources 20, and then generate a transparent layer or grid to be overlaid upon and registered to the underlying primary image. The transparent layer generated by system 10 then serves as a platform configured to arrange and link to other data (information, files, and/or documents), again from data sources 20, corresponding to certain locations or objects on the underlying primary image, without the need for modifying or re-processing the underlying primary image.

As illustrated in the accompanying figures, the present invention maintains the ability to create a transparent digital layer that can be overlaid upon and registered to a large number of document formats. Each such transparent digital layer can contain an unlimited number of link icons (or “links”), which can address any number of corresponding legacy and new information sources, including documents, data and software applications, located within a corporate information environment or across web connections, whether they be wired or wireless connections. Registration of the transparent layers and the placement of the link icons can be done based either on a local coordinate system (local to the image) or a global coordinate system, such as latitude and longitude, provided the primary image document is geo-coded. The link icons are completely separate from and not embedded within the primary image documents over which they are laid. However, the links may be, and typically are, visually related to a particular location or object in the underlying document image by the user.

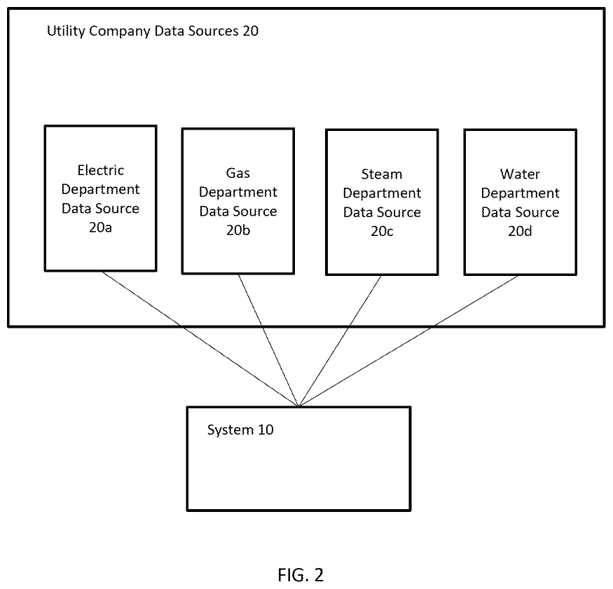

In accordance with one embodiment of the present invention, and in order to illustrate a typical installment utilizing system 10 and to facilitate further exemplary discussion of the present invention, FIG. 2 illustrates an arrangement of system 10 coupled to a series of legacy data sources 20 that may occur in a real world setting. One or more of the data sources may be disparate from one another, for example, owned, managed, controlled, and/or maintained by different entities. For example, in the arrangement of FIG. 2, a utility company has a plurality of existing legacy databases/data sources 20. Each data source 20 may be maintained by a separate department (entity) within the larger company. Alternatively, one or more of the data sources may be maintained by a different company (entity). The data sources 20 may each be running on separate, non-compatible proprietary or commercial software. Furthermore, data contained on each of the data sources may be of a format not capable of easy manipulation or rendering. It is understood that the arrangement shown in FIG. 2 is for exemplary purposes and is in no way intended to limit the scope of the present teachings.

For example, an electric power department data source 20a may have existing data in the form of images, media (e.g., audio, video), and text. The image files are non-linkable raster image files and furthermore, the data is stored in a manner non-compliant with the existing data architecture on a gas department data source 20b, steam department data source 20c, water department data source 20d, etc. Reworking: 1) the image files into modifiable smart images, capable of incorporating embedded links; and 2) the data architecture of data sources 20a-20d into compatible formats, is extremely time consuming and expensive and in many cases is simply impossible, as the departments may not wish to have their data altered.

Each data source 20 may contain one or more information, files, and/or documents (herein collectively referred to as “document” or “documents”). A document in a given data source 20 may be related to a built environment or a natural environment. The term “built environment” refers to infrastructure, facilities, or any man-made structure or surroundings. A built environment may encompass places and spaces created or modified by people, such as buildings, parks, transportation systems, etc. For example, a built environment may refer to an electric power grid. A document related to a built environment, such as the electric power grid, may pertain to a particular transformer in the grid, including location and time information, health status information, maintenance reports, calibration reports, etc. The term “natural environment” indicates any naturally-occurring place and space. For example, a natural environment may refer to a landform, for example a river, lake, hill, mountain, etc. A natural environment may also refer to a stand of trees, a forest, wildlife, or even the air in a particular location. Accordingly, a document relating to a natural environment may include, but is not limited to, weather data, climate data, atmospheric data, data on natural resources (e.g., minerals, soil type, etc.), geological features, geographical features, and data on plant life or wildlife. Such information, for example, may include location and time information, soil type data, population of each type of wildlife, migration of wildlife, or growth cycle of plant life.

Data sources 20 refer to existing databases managed, controlled, and/or maintained by the user or other entities. Broadly, any data, either image, computer aided drawing, 2D or 3D drawing, building information modeling (BIM) model, video, audio, text, spreadsheet, presentation (slideshow), one-line diagram, map, schematic, or executable programs, that are to be the subject of a transparent layer rendering (primary file) or are to be linked to from such a transparent layer are referred to throughout as existing or legacy data. Data sources 20 are the sources of the compilation of all such data. FIGS. 1 through 5 are not intended to imply proximity of such data, merely that data sources 20 are outside of system 10 and maintain the legacy data. Data sources 20 that are located remotely, such as data handled by third party vendors are all within the contemplation of the present teachings.

One such principal legacy data contained within data sources 20 generally includes text and image data 22 in various formats. The following is an exemplary list of file types contemplated for use with the present invention: DWG, AutoCAD, IDW—Inventor, DGN—Microstation, PLT—Calcomp, CGR—CATIA, SHP—ESRI, DRW—Pro Engineer, PRT—Pro Engineer & Unigraphics, SLD—SolidWorks, GBL—Gerber, CAL—CALS, COT—Intergraph, GIF—GIF, PDF—Adobe, SVG—Scalar Vector Graphics, JPG—JPEG, VSD—Visio, PPT—Powerpoint, BMP—BitMap, TXT—Text, DOC—Word, XLS—Excel, CSV, XML, WRK—Lotus, MDB—Access, WPD—Wordperfect, RVT/RFA/RTE—Autodesk Revit, DXF—AutoCAD. This list is intended to be exemplary only and in no way is intended to limit the scope of the present teachings.

These files refer to images such as one-line diagrams, maps, floor plans, building plans, charts, workflows, photos and other such images, as well as data files, related to any object that may appear on or be related to one of the images. Although there are too many possible types of data to list as examples, a brief illustrative example, elaborated on below, may be an image of street map for a utility company (primary image file) and a text document listing information related to a particular manhole, power feeder, telephone/electric pole, etc. (text/data file that is the subject of a link) that is represented on that street map. As noted above, other data stored in data source 22, may further implement additional user proprietary and third party software.

Furthermore, in addition to standard text and image files, data sources 20 also may include dynamic data sources 24 corresponding to frequently updated or real-time information from sensors or other updating data (pump pressure indicators, weather information, release valve pressures, temperature, voltage and current variations, etc.). For example, dynamic data source 24 may include a table relating to sensor data, such as a temperature sensor. Rather than a simple static or semi-permanent data, this dynamic data source 24 constantly registers updated temperature readings from one or more temperature sensors. This data can then be accessed by system 10 in order to provide links to real-time data and events in accordance with the transparent layer and link generating process discussed below.

Yet another form of data within data sources 20 is GPS or other geographic location data 26. Location data 26 from data sources 20 may be used by system 10 to track real-time or frequently updated geographical location data of an object. For example, if a user employs GPS tracking sensors in a given object, location data 26 of data sources 20 stores the location data of the object.

The above types of data found within the data sources 20 are merely illustrative. Any additional legacy data that is used by system 10 in conjunction with the transparent layer generation and link generation discussed below is within the contemplation of the present teachings.

The system 10 is connected or connectable to data sources 20a-20d allowing a first primary file from one of the data sources 20 to be retrieved by the system 10, spatially registered against a system-generated transparent layer, and have links to related or corresponding data placed on the transparent layer, without having to re-format or re-configure any of the existing legacy data (primary file or linked data) from data sources 20. Additional examples of implementations of system 10 are discussed below during the detailed description of the operation.

As shown in FIG. 1, the visual navigation system 10 includes an interface apparatus 11 which is configured to communicate with the data sources 20. The connection between the interface apparatus 11 and the data sources 20 may be achieved via a wired communication line, wirelessly, or a combination thereof. In addition, communication between the interface apparatus 11 and the data sources 20 can be maintained constantly or established on demand upon user input or request by the interface apparatus 11.

In some embodiments, the system 10 may also include a display 12, which is connectable to the interface apparatus 11. In some embodiments, the display 12 is a computing device. In other embodiments, the display 12 is a tablet computing device. In yet other embodiments, the display 12 is a mobile computing device, such as a smart phone. The display provides a user interface for a user to interact with the system 10. For example, the user interface provided by the display 12 may be an application (e.g., smart phone app). In addition, or alternatively, the display 12 may use a browser-based user interface. The display is configured to receive user input, including the user's selection of a primary file, which contains a plurality of objects. Each object relates to a component or equipment of a built environment or a feature or characteristic of a natural environment. In other embodiments, the display is not part of the system 10, but is configured to connect to the system 10.

In one arrangement, the interface apparatus 11 is configured as a processor or server having a number of functional modules therein that are coupled to data sources 20. In other arrangements, the functional modules may be embodied in multiple processors or servers. For example, each functional unit may be a processor or computing device. The interface apparatus 11, in some arrangements, may simply be in the form of an application installed on existing computers either within or external to a user's existing computer architecture. Furthermore, modules listed independently in the Figures, and discussed as such below, may be combined into larger multi-function modules as desired or moved as certain legacy data source architecture and user requirements dictate.

The interface apparatus 11 has a data application integration and administration module 30, a content acquisition and receiving module 40, and a content rendering module 50. These elements of the system 10 perform the process of requesting/retrieving a primary file, generating a transparent layer, and generating links to be added to the transparent layer.

The data application integration and administration module 30 is coupled to data sources 20. The administration module 30 establishes a communication connection to at least one of the data sources 20, so as to configure data retrieved or received therefrom, imported into the interface apparatus 11, into a usable format. Because a user's legacy data is typically stored in one or more commercial or proprietary formats, administration module 30 is used by interface apparatus 11 to ensure that all data available to system 10 is able to be imported smoothly and worked on by content receiver 40 and content rendering module 50. The administration module 30 thus is configured to format documents retrieved or received from the data sources 20 before forwarding the documents to the content receiver 40 for further processing. Additionally, the administration module 30 may include a plug-in manager used to integrate with the existing data management systems employed on data sources 20, inheriting the user's permissions/passwords, and retrieve access files and metadata for legacy data location information. For example, potential legacy data sources 20 may operate on systems such as FileNet, TeamCenter, Adept, Vault, Oracle, or other custom application software.

As shown in FIG. 1, the content receiver 40 is coupled to administration module 30 and is configured to request (and subsequently receive) or retrieve data (information, files, and/or documents) from the data sources 20. As noted earlier, the present invention is designed to obtain a first primary image or spatial file (such as a map or one-line diagram), generate a transparent layer overlaid over the top of the primary image and then place links on the transparent layer, linking to other image, text, sensor data, etc. (information, files, and/or documents), relating to the primary file. Content receiver 40 is the component of system 10 that retrieves the data being acted upon, either the underlying primary file content or the link content from data sources 20. In this context, content receiver 40 is first utilized to draw up an initial image data from data sources 20 upon which to generate the transparent layer and is again used when retrieving data to be linked to on the transparent layer. Content acquisition via content receiver 40 may either be a manual process directed by the user, or alternatively, it may be programmed if possible, assuming the underlying primary image file contains some inherent intelligence. A detailed description of the process for data acquisition is discussed below.

A content rendering module 50 is coupled to both the administration module 30 and content receiver 40. Content rendering module 50 is configured to process and render the transparent layer to be overlaid on the primary image file and is further configured to carry out link generation. In particular, content rendering module 50 has an overlay generator 52 and a link generator 54. The overlay generator 52 generates a digital overlay document when the interface apparatus 11 receives a user's selection of a primary file from the display 12. The digital overlay document, which is separate from the primary file, comprises the transparent layer which is to be overlaid on the primary file. Thereafter, the link generator 54 handles processing related to icon generation and placement on the transparent layer as well as generation of the link to the associated data in data sources 20.

The link generator 54 generates a plurality of icons and inserts the icons on the transparent layer of the digital overlay document. Each icon links to one or more documents which are contained in at least one of the data sources 20 and which are related to one of the plurality of objects in the primary file. As mentioned above, each object is related to a component or equipment of a built environment or a feature of a natural environment. The links created by the link generator provide for multiple paths for navigation between information, files, and/or documents. The paths provided by the links are multi-directional and non-hierarchical. Without modifying the primary file, the overlay generator 54 superimposes the digital overlay document over the primary file and spatially registers the digital overlay document to the primary file so that each icon superimposes over one of the plurality of objects relating to the one or more documents that the icon links to. During this process, the digital overlay document remains separate from the primary file, and the primary file is not modified. In some embodiments, the overlay generator and the link generator may each comprise their own processor. In other embodiments, one processor embodies the entire content rendering module 50 and thus both the overlay generator and the link generator.

Thus, the content rendering module 50 is directed to place icons or links on the transparent layer of the digital overlay document in the desired locations and further to work in conjunction with the content receiver 40 to obtain the necessary stored data from data sources 20 for each of the links. The process for link generation may be initiated by the user or alternatively, may be performed automatically by the system 10. The process for link generation is discussed in greater detail below.

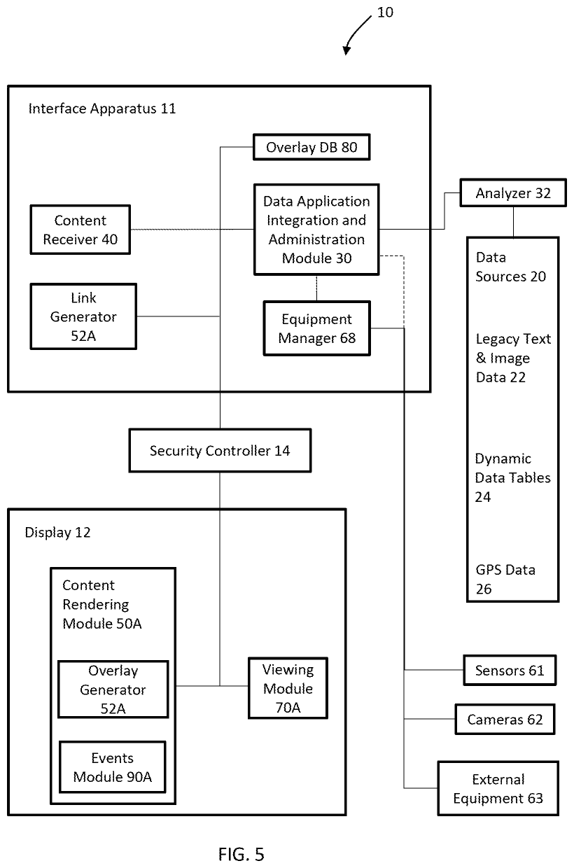

The display 12 is shown in FIG. 1 as being external to the interface apparatus 11. However, the display may be incorporated within the apparatus 11 itself if desired. The display 12 is a computing device and interface for the user to interact primarily with content rendering module 50 and content receiver 40, allowing the user to retrieve a primary file (e.g., primary image file) and generate the desired links on the overlaid transparent layer. In FIG. 5, display 12 is combined or incorporated into the user's application (content rendering module 50a and viewing module 70a).

Viewing module 70 is coupled to the various components of system 10, and configured to facilitate any necessary image display integration. For example, much of the legacy data in data sources 20 may be in different formats (.tif, .dwg, .svg, .pdf, etc.). In some embodiments, the link generator 54 of content rendering module 50 may have its own viewing software. Viewing module 70 is able to integrate the various viewing formats so that they are smoothly viewed by the user, such as on the display 12.

The system 10 may further comprise an overlay database 80. The overlay database is either an internal component of the interface apparatus 11 as shown in FIG. 1, or is an external part (e.g., located remotely from the interface apparatus 11) communicatively connected to the interface apparatus 11. The overlay database 80 is configured to store the digital overlay document with the plurality of icons, including information regarding the generated links on the transparent layer. As noted above, the original primary file as well as the legacy data that is being linked to on the overlaid transparent layer are all stored, unedited, in data sources 20. However, once a transparent layer/digital overlay document is generated for a particular primary file and various links are placed thereon, the layer and its corresponding imprinted link data, location of links with respect to the layer image and other related data generated by content rendering module 50 are stored in the overlay database 80. In some embodiments, such data in overlay database 80 may alternatively, or additionally, be stored locally on data sources 20, but for illustrative purposes, data corresponding to the transparent layer and links (address of data and location on transparent layer) is considered stored in overlay database 80.

Events module 90 in content rendering module 50 is configured to handle links on the transparent layer of the digital overlay document that require constant update. As noted above, some data source information includes dynamic sensor data 24 and location data 26. When a link is generated to such data, events module 90 polls the data (or table containing the data) at some regular interval and updates the link. For example, in the case of a sensor data 24, if the sensor records an event that exceeds some threshold, like a temperature threshold, then events module 90, after the next timed polling of such data, may change the status of the link to indicate to the user a change in status. This change may come in the form of, for example, a flashing link, a change in color of the icon, the addition of a notification badge into the icon, or a change in location of the icon on the transparent layer.

The interface apparatus 11 further includes a security control unit or controller 14. The security controller 14 is configured to evaluate a user's credential (e.g., login name and password, security token) before allowing the user access to the interface apparatus 11 and/or data sources 20. The system 10 is arranged so that in response to a subsequent selection of one of the icons by the user, the security controller 14 determines if the user is authorized to view the one or more documents which the user-selected icon links to. When the security controller 14 determines and confirms user authorization, the one or more documents which the user-selected icon links to is transmitted to the display 12 for presentation. The security controller also evaluates the user credential to determine whether to connect the interface apparatus 11 to the display 12 in order to provide communication between the display and the interface apparatus. In some embodiments, the security controller utilizes a multi-factor authentication to authenticate the user seeking access to the interface apparatus 11. That is, the security controller 14 is able to confirm a user's claimed identity and grant access to the system 10 only after the user successfully enters two or more pieces of evidence to an authentication mechanism. The two pieces of evidence, for example, may include: something the user knows (e.g., login name and password); and something the user has (e.g., security token). The security controller 14 may provide secured access through use of disconnected tokens (e.g., key fob token), connected tokens (e.g., card readers, wireless tags, USB tokens), or software tokens.

With the security controller 14, a user may only be granted access to certain types of information, files, and/or documents. Each of the plurality of documents within each data source 20 is assigned a classification level based on a sensitivity of data contained therein. The security controller 14 determines based on the user credential whether the user is authorized to view a particular document depending on the classification level of that document. For example, the security controller will grant access to a nuclear material document stored on a data source managed by a nuclear power plant as long as the user has the necessary security clearance. In addition, or alternatively, a user may have restricted access based on the originating data source. For example, a user may only be allowed to obtain and view information, files, and/or documents originating from a designated data source 20. The security controller may also be configured to provide different security levels so that it grants or denies access to users based on their respective reading, editing (writing) and/or administrative permissions, as well as based on the type of users.

In some embodiments, the data sources 20 are managed by different entities (e.g., companies, departments, etc.). Each entity may have its own authentication authority. Accordingly, when a user selects an icon on the transparent layer, the security controller 14 communicates with the authentication authority of the respective entity managing the data source which contains the document linked to the selected icon. The authentication authority responds by providing feedback to the security controller, either confirming or rejecting secured access by the user to the document. In some embodiments, if the security controller determines that the user is not authorized to view a selected document, the security controller transmits a warning signal to the authentication authority of the respective entity managing the data source which contains the document.

The security control unit 14 may include a security database which stores information about all users authorized to access the interface apparatus. This security database may be part of the security control unit. Alternatively, the security database may be another element within the interface apparatus 11. The security control unit 14 may be configured to monitor logins and logouts of each user, and save this data in the security database. The login and logout data can include a timestamp and location of the respective user logging in or logging out of the system 10. In some instances, the security control unit tracks selection of icons by the user and the documents which the user-selected icons link to.

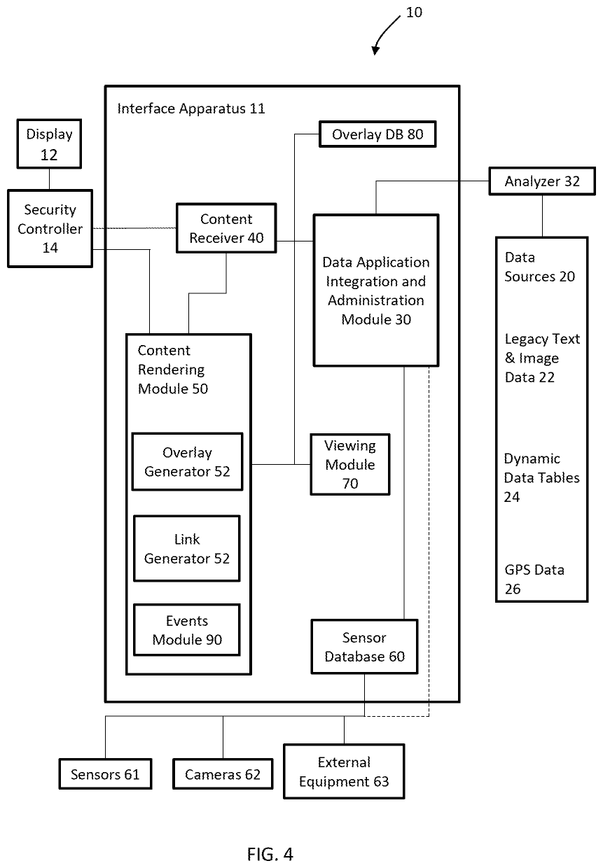

In FIG. 1, the security controller 14 is an internal component of the interface apparatus 11. However, the security controller 14 can be a component external to the interface apparatus 11, as shown in FIG. 4. Here, security controller 14 is connected between the display 12 and the interface apparatus 11. With either configuration, the security controller 14 evaluates user credential (e.g., login name and password, security token) to determine whether to connect the interface apparatus to the display in order to provide communication between the display and the interface apparatus.

The content rendering module 50 may be configured to perform additional processing with respect to transparent layer generation and link generation. For example, the link generator 54 generates a plurality of data icons and inserts the data icons on the transparent layer of the digital overlay document. Each data icon links to one or more documents which are contained in at least one of the data sources 20 and are related to one of the plurality of objects (within the primary file). The link generator 54 also generates a plurality of sensor icons and inserts the sensor icons on the transparent layer of the digital overlay document. Each sensor icon links to a sensor that provides data about one of the plurality of objects (within the primary file). The sensor may comprise an external equipment 63 capable of taking measurements relating to a component in a built environment or a feature in a natural environment. In some instances, the external equipment 63 may be actual component in the built environment. The sensor may also comprise a camera 62 or a sensor 61. The camera 62 is configured to provide video of one of the plurality of objects. For example, the camera 62 may provide photos (e.g., still image) and/or video (e.g., moving image) of a transformer operating within a power grid. As another example, the camera 62 may provide photos and/or video of a river for monitoring water levels. The sensor 61 may be integrated with or form a part of the equipment or component (in the built environment) to which the sensor 61 provides data. Examples of sensor 61 include, but are not limited to, an acoustic sensor (e.g., hydrophone, microphone), a vibration sensor (e.g., seismometer), a chemical sensor (e.g., carbon dioxide sensor, carbon monoxide detector, electrochemical gas sensor, spectrometers), an electric sensor (e.g., current sensor, voltage sensor, electroscope, hall effect sensor, magnetometer, magnetic field sensor), an environmental sensor (e.g., actinometer, air pollution sensor, fish counter, soil moisture sensor, tide gauge), a weather sensor (e.g., barometric pressure sensor, anemometer, rain gauge, snow gauge), a flow measurement sensor (e.g., flow meter, pressure-based meter), a radiation sensor, an optical sensor, a pressure sensor, temperature sensor, or a GPS sensor.

The overlay generator 52 thereafter, without modifying the primary file, superimposes the digital overlay document over the primary file and spatially registers the digital overlay document to the primary file such that each data icon superimposes over one of the plurality of objects relating to the one or more documents that the data icon links to, and such that each sensor icon superimposes over one of the plurality of objects about which the sensor provides data. If one of the data icons is selected by the user, the one or more documents which the user-selected data icon links to is transmitted to the display 12 and subsequently presented. If one of the sensor icons is selected by the user, the display 12 presents data measured or obtained by the sensor which the user-selected sensor icon links to.

As shown in FIG. 1, the external equipment 63, camera 2, and sensor 61 may be communicatively connected to the administration module 30 of the interface apparatus 11. In addition to, or alternatively, the external equipment 63, camera 62, and sensor 61 may be communicatively connected to a sensor database 60, which is then connected to the administration module 30. Each sensor (external equipment, camera, sensor) is assigned an internet protocol (IP) address. The sensor database 60 stores the IP address of each sensor and a routing table which lists a plurality of communication routes to each sensor. When one of the sensor icons is selected, the interface apparatus 11 and for example the administration module 30 retrieves from the sensor database 60 the IP address of the sensor which the user-selected sensor icon links to. Using the IP address, the interface apparatus sends a request signal to the sensor to receive data from the sensor. In response, the sensor transmits data to the interface apparatus, wherein the data can be real-time data or data that was previously recorded by and locally stored on the sensor.

In some embodiments, the sensor database 60 is configured to request and poll data from some or all of the sensors (equipment 63, camera 62, and sensor 61) at pre-set intervals. Note, the sensor database can poll the sensors at the same or substantially same time. Alternatively, the sensor database can poll the sensors sequentially or successively, with or without time spaced between each polling action. The sensor database 60 is configured to store data from polling the sensors and generate a historical record. When one of the sensor icons is selected, the content receiver 40, through the administration module 30, retrieves or receives from the sensor database 60 the historical record of the sensor which the user-selected icon links to. Thereafter, the display 12 presents the historical record.

In addition to or instead of the sensor database 60, the interface apparatus 11 may be configured to connect to an external server that is controlled or managed by an entity and collect data from sensors controlled or managed by the entity. Such external server may be similar or equivalent to the data sources 20. When a user selects one of the sensor icons on the transparent layer, the interface apparatus (administration module 30 and/or content receiver 40) obtains the appropriate sensor data from the external server.

As discussed above, the interface apparatus 11 includes an events module 90. The events module is capable of monitoring the data sources 20 for new and/or updated documents or monitoring the sensors (equipment 63, camera 62, and sensor 61) for new and/or updated data. The events module instructs the link generator 54 to generate a notification marker in the data icons and/or the sensor icons when a new/updated documents or new/updated data is detected.

The sensors (equipment 63, camera 62, and sensor 61) associated with the sensor icons may be arranged in one or more networks, and in particular, one or more Internet of Things (IoT). In some embodiments, when one of the sensor icons is selected, the interface apparatus 11 connects directly to the IoT network that includes the respective sensor which the user-selected sensor icon links to. This direct connection provides communication between the interface apparatus 11 and the respective sensor. In some embodiments, the IoT networks are managed by different entities (e.g., companies, departments, etc.) Each IoT network comprises an IoT management interface module, wherein the interface apparatus 11 (administration module 30 and/or content receiver 40) interacts with an IoT management interface module to provide communication with the respective sensor. The interface apparatus 11 interfaces with the appropriate IoT management interface module using an application programming interface (API). Some examples of API that may be used include, but are not limited to, ASPI, Cocoa, Carbon, DirectX, Java APIs, ODBC, OpenAL, OpenCL, OpenGL, SAPI, DSL, etc. It is an important feature of the visual navigation system 10 to integrate with and/or function with IoT networks since IoT promotes increasing level of awareness about the world and provides a platform from which to monitor the reactions to changing conditions in the world.

The system 10 may also include an analyzer 32. The analyzer may be part of the interface apparatus 11 (FIG. 1) or may be a system component separate from the interface apparatus 11 (FIG. 4). The analyzer 32 is configured to scan the primary file for keywords. For each keyword found, the analyzer 32 then searches for documents (information, files, and/or documents) within the data sources 20 that relate to or contain the keyword. The analyzer 32 controls the link generator 54 to generate—automatically or in response to user input—an icon for each document found and insert the icon on the transparent layer so that the icon superimposes over a location where the keyword appears in the primary file. For example, the analyzer analyzes the primary file for geo-coded data. The overlay generator 52 uses the geo-coded data to relate the digital overlay document to the primary file.

The analyzer 32 reviews the documents in the data sources 20 for location data, wherein for each document having location data, the link generator 54 generates an icon linking to the document and inserts the icon on the transparent layer based on the location data. In some instances, the digital overlay document is related to the primary file by a coordinate system (e.g., global coordinate system).

The system 10 may be configured such that selection of the primary file is performed automatically by the interface apparatus 11 based on the user credential provided by the user. This is in contrast to the configuration where the interface apparatus 11 awaits for the user to select a primary file before any processing is performed by the interface apparatus. The primary file may comprise one of a one-line diagram, map, a blueprint, a floor plan, a building plan, a chart, a workflow, or an image. The primary file may comprise one of a 2D or 3D drawing, BIM model, a computer aided drawing (CAD), an image file, a map, a schematic, a slideshow file, a text file, a spreadsheet file, an audio file, video file, or database file. These lists are merely exemplary and are not intended to limit the primary file thereto.

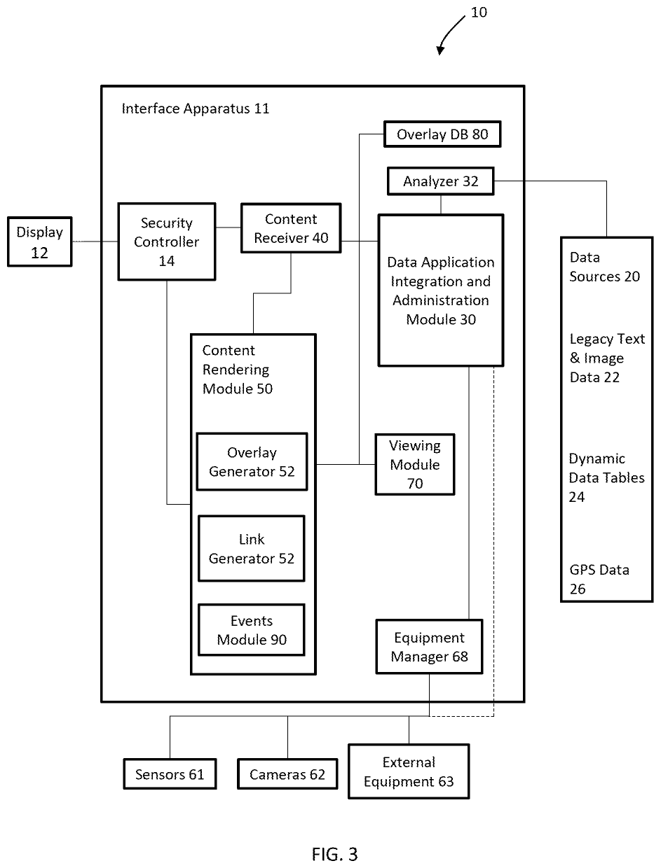

In addition to the above features of the interface apparatus 11, an equipment manager 68 may be included, as shown in FIG. 3. The equipment manager is configured to monitor a status parameter of one of the equipment/components in the built environment or a feature in the natural environment. If the status parameter detected by the equipment manager is outside a predetermined threshold, the equipment manager will transmit a corresponding alert signal. For example, if the voltage in a particular electrical transmission line exceeds a predefined voltage (e.g., 500 kV), the equipment manager will recognize this condition and transmit an alert signal. In some cases, the alert signal indicates that the equipment/component requires repair or maintenance. In other cases, the alert signal indicates that the equipment/component needs replacement. The equipment manager 68 can also determine whether repair or replacement of the equipment/component is required based on a historical trend of the status parameter. The historical trend may be provided by the sensor database 60. In some embodiments, the sensor database 60 and the equipment manager 68 embody a single unit within the interface apparatus 11. In addition, or alternatively, the equipment manager 68 can determine whether repair or replacement of the equipment/component is required based on the status parameter of another equipment/component. For example, the equipment manager 68 may monitor the current in a particular electrical transmission line, and if the current exceeds or is below a predefined value, such observation indicates that a component upstream in the electrical transmission line has failed and requires replacement or repair.

The interface apparatus 11 may also be configured to function and communicate with an auxiliary system which provides at least one of asset management or work management. The cooperation between the visual navigation system and such auxiliary system will help maximize efficiency in handling assets and work orders for example. The auxiliary system may also be configured to produce documents for storage in the data sources 20.

FIG. 5 illustrates an alternative arrangement for system 10, where a content rendering module 50a and viewer integration module 70a are located external to interface apparatus 11 on a user's computing device (e.g., display 12). Here, the overlay generator 52a is moved to the user's computing device and the link generator 54a remains within the interface apparatus 11 to handle link relationships, and other link generation functions, apart from directly rendering the content of the links and supporting the transparent layer.

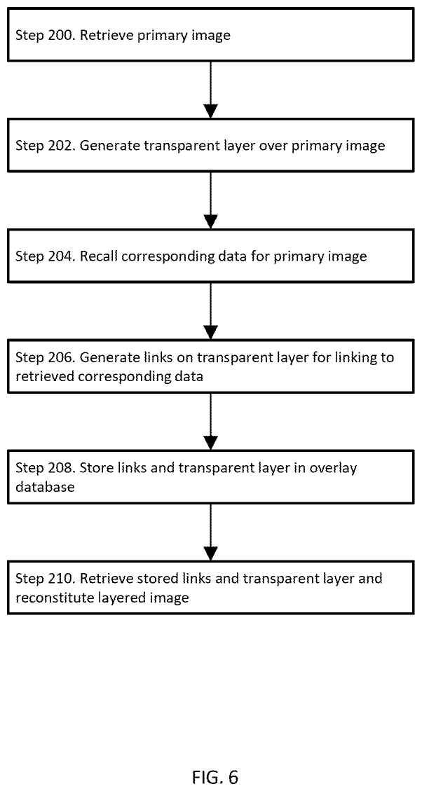

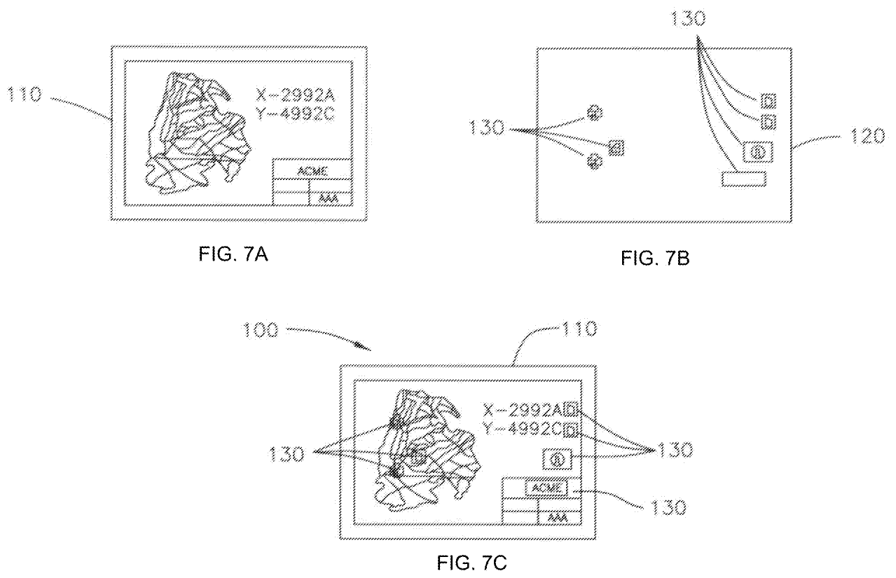

Turning now to an exemplary implementation of the present teachings, FIG. 6 is a flow chart of the operation of system 10, and FIGS. 7A-7C show an exemplary layered image 100 in accordance with one embodiment of the present teachings. As discussed earlier and shown now in FIGS. 7A-7C a layered image 100 (FIG. 7C) is formed from an underlying primary image 110 (FIG. 7A), a transparent link layer 120 image (FIG. 7B) to be overlaid over primary image 110, and a series of links 130 disposed on transparent layer 120. As shown in FIG. 7C, transparent layer 120 with links 130 is superimposed over primary image 110 resulting in layered image 100, where links 130 appear directly over primary image 110. As discussed throughout, layered image 100 allows primary image 110 to be enhanced to include links 130 to other data related to primary image 110, such as data corresponding to objects on primary image 110, without the need to alter, rearrange, or modify the existing document structure of primary image 110. It is understood that this is intended as an exemplary model of layered image 110. However, it is understood that any similar layered image formed from a non-embedded transparent layer overlaid over a primary image is also within the contemplation of the present teachings.

In the present example shown in FIG. 7, a municipality may have a map stored in data sources 20 as well as information concerning certain emergency responses. Thus, the map of the region is retrieved as primary image 110 and transparent layer 120 is created for placing links. The user then places links 130 on the transparent layer over such items as hospital locations, police stations, etc., where the links 130 maintain addresses to other data in data sources 20 that correspond to such objects, i.e. hospital information (street address, telephone, emergency capacity, trauma level, associated ambulance services, etc.) and police station information (street address, capital of station, emergency services capacity, etc.) and/or links to other documents such as floor plans which then can become a new primary image.

In one embodiment of the present teachings, the process for generating such a layered image 100 begins at step 200, where a user at display 12 selects a primary image 110 from data sources 20 to be processed into a layered image 100 (FIG. 6). Content receiver 40 retrieves primary image 110 from legacy data sources 20 and delivers it to content rendering module 50.

Next at step 202, overlay generator 52 of content rendering module 50 generates transparent layer 120 which is rendered over and spatially registered to primary image 110 resulting in a first primary image 110 viewable through an overlaid transparent layer 120. At step 204, the link generator 54 then begins to retrieve link data from legacy data sources 20. As noted above, this is data, such as text, additional images, sensor data, GPS information, etc., that is related to some object on the primary image 110. At step 206, the link generator generates links 130 on transparent layer 120 directly overtop of the particular object on primary image 110 to which the additional data corresponds. The icons used for each link 130 preferably identify/relate to the attached data. For example, if link 130 is to a data file, the icon used would preferably be in the form of a note paper, a hospital link 130 can be designated by an “H”, etc.

It is noted at this time that this process of generating links 130 is facilitated by link generator 54 of content rending module 50 and can be either a manual process or an automated process. In the manual process, the user physically drags and drops the icon or link 130 on the desired location on transparent layer 120 over primary image 110 and then links to the corresponding data. In the automated process, where the primary image 110 has some intelligence, content rending module 50 may read/scan primary image 110 for certain information and drop links onto transparent layer in the corresponding locations drawing from a list of links 130 created by the user. Details of the automated and manual process are discussed in more detail below.

At step 208, once the links 130 are all in place, content rending module 50 stores the transparent layer 120 and links 130 (location and address data) in overlay database 80. A user wishing to view a layered image on system 10 at step 210 can simply recall a primary image 110, retrieve the stored transparent layer 120 and links 130 from overlay database 80 so as to reconstitute layered image 100 using viewing integration module 70 and display 12. It is understood that this process is an exemplary process for generating layered image 100. Any similar process employing similar steps and elements is also within the contemplation of the present teachings.

The following are additional examples of implementations of system 10 as well as more detailed explanations of certain steps from the layered image 100 creation process outlined in FIG. 6.

Beginning with link generation step 206, as noted above, this process can be performed manually, or automatically. Once a user designates a primary image 110 and generates a transparent layer 120, the user can then simply recall additional data from data sources 20 that correspond to objects on primary image 110.

In one embodiment of the present teachings for example, if the user is a utility service, and the primary image 110 is street map of a ten block area, then the recalled corresponding data may include but is not limited to: text files relating to manhole covers, image files (maps) of under street level feeders, text files relating to those same feeders, text files on pot heads, temperature sensor tables relating to the feeder temperatures, other text and image data relating to steam and water supply pipes from other departments, work history files for certain locations/objects, transformers, scheduling data for schedule of works performed and to be performed, etc. This data is recalled from data sources 20 using basic category search methodology, using search terms, and limits, according to how the data is stored in data sources 20. It is understood that the types of data related to an object on primary image 110 is nearly limitless. The present teachings contemplate any such related data that is retrieved for the purpose of generating a link 130 on transparent layer 120.

Once recalled, the user views primary image 110, locates an object on the image such as a manhole, places an icon/link 130 on the transparent layer 120 and attaches the address of the corresponding recalled data to link 130. This link location and address information is stored in overlay database 80 as discussed above in step 208 for future viewing so that when primary image 110 is recalled at step 210, the corresponding transparent layer 120 and links 130 can be viewed together as layered image 100.

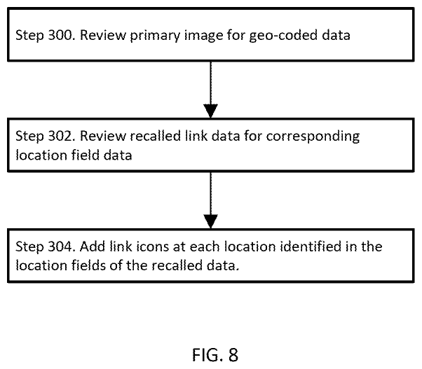

However, in the event that primary image 110 maintains either vector data or some other geocoding such as latitude/longitude data, it is possible to have content rendering module 50 automatically place links 130 on transparent layer using such data. The flow chart of FIG. 8 illustrates this process which is a sub-process of step 206 from FIG. 6. For example, in one embodiment of the present invention, at a first step 300, the recalled primary image 110 is reviewed for location parameters and the rendered transparent layer 120 is coordinated to have identical location parameters. The location parameters of primary image 110 are obtained using the geocoding embedded in primary image 110.

Next at step 302, the corresponding retrieved data from data sources is also reviewed for location data. For example, in the above arrangement, primary image 110 utility map is geo-coded with latitude longitude information. Furthermore, the manhole text data each contain a latitude longitude field as well. Thus, at step 304, content rendering module 50 simply reads the list of recalled data from data sources 20, and places a link image 130 on each location on transparent layer 120 relating to the information from each of the recalled location fields. Obviously, this process is expandable to any geo-coded primary image 110 and any links 130 that maintain a data field with corresponding geo-coded information.

Turning now to typical implementations of system 10, the following are samples of viewing layered images 100, as stored in overlay database 80 and data sources 20 according to the processes outline above and as further illustrations of step 210 above.

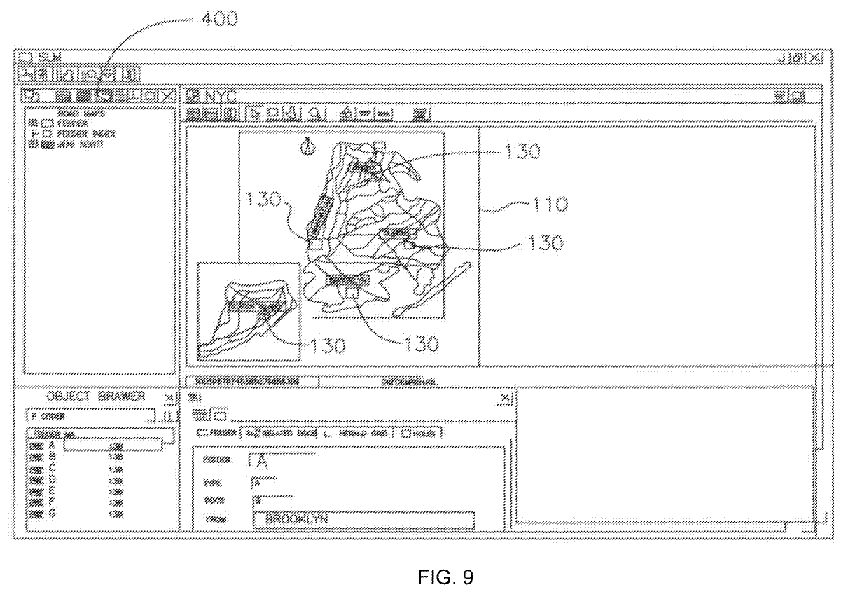

In one embodiment of the present invention as illustrated in screen shot FIG. 9, a utility company may for example employ system 10 in order to maintain an integrated data network including all of their electric grid, steam grid and gas grid, employing system 10 to cross connect all related data images, files, programs, real time sensors, etc., into a geographically vertically integrated data network. Accordingly, beginning with each desired map, or image file, layered images are generated according to the above process for all data contained in data sources 20, resulting in a complex data structure, allowing a user to easily view any image as a layer image 100, with links 130 to all related data, corresponding to the objects on the corresponding primary image/map 110. This process is done without altering or modifying the underlying documents or changing them from their original format.

Thus, once all the related data is entered according to the process steps 200-208, at step 210 the user may begin viewing a particular image by retrieving a primary image 110 of map of a city (in this case New York City). In the following example illustrated in successive screen shots, a user may be looking to find a certain electric feeder based on its location physical location and then look for any necessary related information regarding that feeder. Thus, once primary image 110 of New York City is retrieved, transparent layer 120, overlaid over primary image 110 (not shown as it is transparent) resulting in a layered image 100 having five links 130 thereon, one for each Borough. In this case, each link 130 is a link to another map file for the particular borough.

Tree links window 400, shown in screen shot FIG. 9, includes a link tree of all of the available links 130 that may be associated with the primary image 110 currently being viewed. Obviously, because primary image 110 here is a map of the entire city, every available link in the city is somehow related to this map. Currently, in the view shown, only the five links 130 to other borough maps are shown.

Typically, a filter arrangement is applied so that only the desired links are shown. Such a filter is applicable to all layered images 100 discussed throughout. This filtering mechanism allows the user to view as many or as few links 130 as desired.

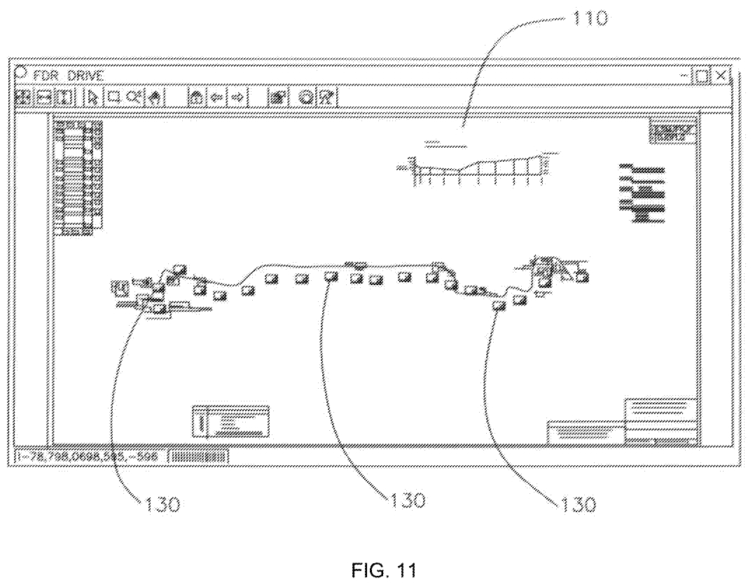

Further, object browser 402, also illustrated in FIG. 9, allows a user to work from the links 130 up, rather than from primary images down. For example, FIGS. 9-14 illustrate a process whereby a user is using the layered image 100 as a means for navigating down to a particular location (in this case a feeder in Brooklyn), to view links 130 associated with that location. However, using object browser 402, if the actual object name such as “feeder XYZ” is already known, and the user wishes to skip directly to that object, then he can simply select that link 130 from object browser 402 and system 10 will recall layered image 100 of that feeder map (FIG. 11, discussed below).

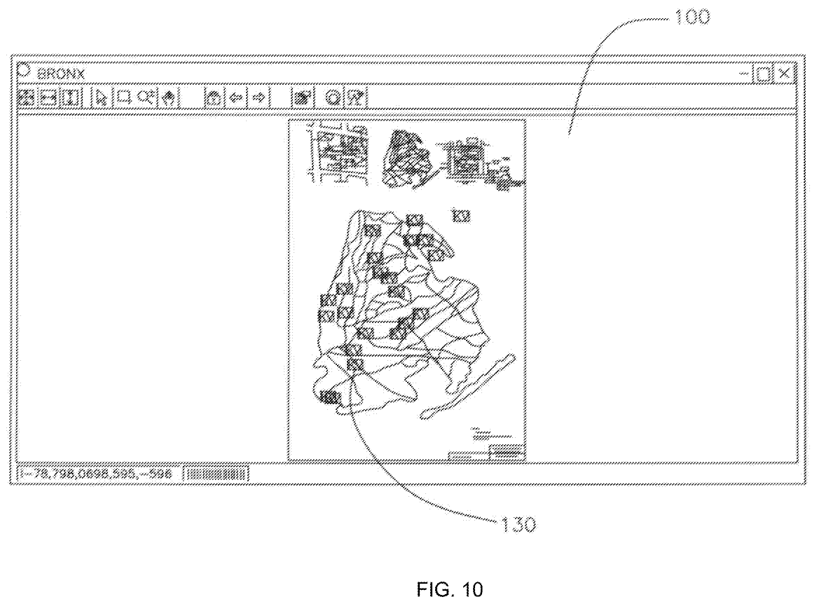

Referring back to FIG. 9, assuming a user clicked on the link 130 for the borough of Brooklyn, viewing module 70 of system 10 recalls the borough map of Brooklyn, as a primary image 110, with the associated transparent layer 120, and each of the links 130 corresponding to some electrical grid component. Thus, FIG. 10 shows a layered image 100 that includes a primary image 110 of Brooklyn, a transparent layer 120, and links 130 related to electrical feeder information. In this instance, the filter arrangement is set to show only feeders, but obviously additional links in the borough of Brooklyn are available if desired.

The user can next click on a desired link 130 exhibited on layered image 100 shown in FIG. 10, which in turn recalls a CAD drawing primary image 110 of the underground feeder map for the feeder selected, with associated link images 130 shown on the superimposed transparent layer 120. This is shown in the layered image 100 in FIG. 11. As with all of these images, the links and transparent layer data are recalled from overlay database 80 and the primary image 110 is recalled from the data sources 20.

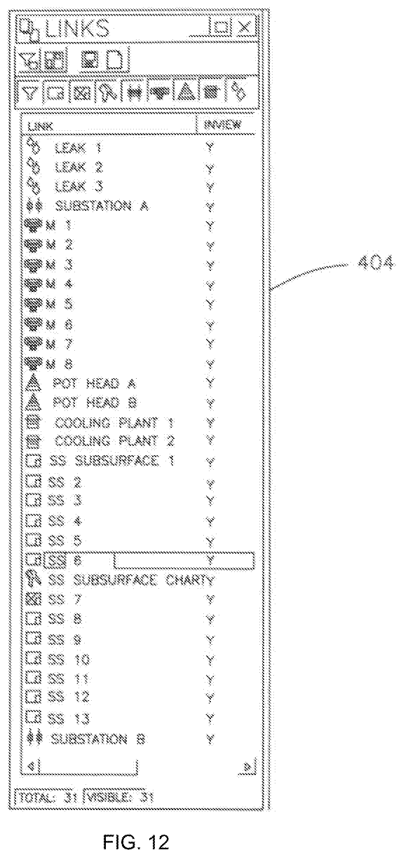

At this stage of this process of moving graphically down through files using the link images as shown in FIGS. 9-11, a link box 404 may always be recalled listing all of the links 130 that are present on any given layered image 100. FIG. 12 shows a sample links dialog box 404. This links dialog box can be recalled on any screen illustrated previously (FIGS. 9-11). Here, links 130 may be to any type of relevant data in data sources 20 that correspond to objects on primary image 110. For example, the links 130 may be to raster images of a particular portion of the feeder, photograph scans of portions of the feeder, work history text files, related non electrical links (such as nearby water and steam pipes), pot heads, transformers and the like.

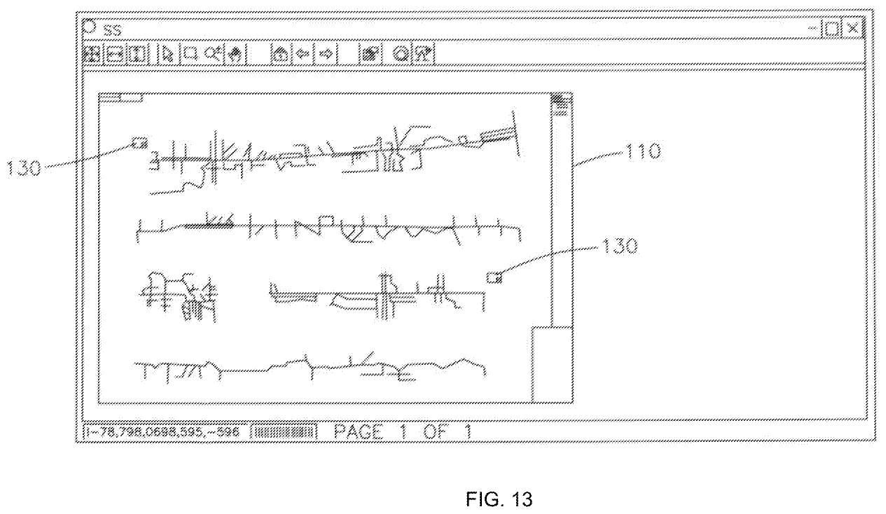

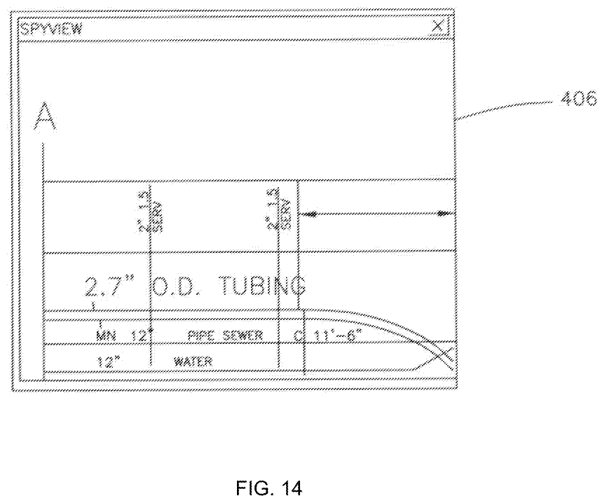

If the user were to link to a particular raster image from the screen of FIG. 11, a new screen (FIG. 13) is recalled displaying the raster image as a layered image 100, again with any stored links 130 superimposed via transparent layer 120. Links 130 on this image may be to related raster images such as the adjacent (geographically speaking) raster image of the feeder's blueprint based on match lines. A spy view feature window 406 is shown in the screen of FIG. 14, relating to an expanded view window from a portion of the screen in FIG. 12.

Thus, as described above, the present teachings allow for the integration of legacy data from data sources 20 without the need to modify or re-configure primary images 110, simply creating layered image 100, by superimposing transparent layer 120 and associated links, storing this link data in overlay database 80, to be recalled upon retrieval of the primary image 110.

Additionally, the transparent overlay or layer with the icons placed on them enables easy update of the icons (SLM, spatial linking methodology) when the underlying document(s) or drawing(s) is modified from one release to the next. A user can slide the overlay over the new release of the drawing or document and can make adjustments to the icons just where there are changes in the new release.

The present teachings have many other applications in the utility field. For example, in a power plant, such as a nuclear power plant, various valves and switches must be managed in related groups and sequences, rather than individually. The present teachings provide a solution with the storage of relationships between the icons on such switches and valves on the engineering drawings from the plant, without editing the underlying primary image 110 files such as the piping blueprints.

The information obtained from the spatial interrelationship between various link icons 130 greatly improves the management ability of a number of other third party software as well. It can be used to direct the manner in which information in a linked third party project is used. Third party work order and work management software typically provide schedules for managing individual projects. However, they do not routinely take into consideration potential spatial conflicts, based on the proximity of multiple projects. The present invention has the ability to identify spatial conflicts and to allow for the modification of these schedules and work plans accordingly.

For example, a utility company may maintain a map (primary image 110) of a given street intersection, with the map marking locations (links 130) of manholes or other similar work locations. Each of the manholes may house a number of services such as gas, electric, telephone etc. The utility company may further maintain third party scheduling software which it uses to schedule service work for each of its departments. Typically each department, although using the same utility company maps, employs different scheduling software.

Using the present teachings, the single map of the street intersection (primary image 110) and manholes may be entered into the system with an associated non-embedded transparent layer 120. On the transparent layer 120 over each manhole, links 130 may be placed to each one of the associated scheduling programs for each of the departments that use that particular manhole. In fact, photographs or other digitally stored images of the area may also be linked on transparent layer 120 to assist crews in locating concealed or awkwardly placed work locations, such as partially hidden manholes.

In a first instance, a gas department of a utility company may dig up a particular location to replace a gas line and then close the area after completion. Separately, the electric department of the same utility company may then schedule a repair on an electrical conduit in nearly the same location for two months later. This will require them to re-dig the area and refill the area after completion.

Using the present teachings, the gas department and electric department may activate the related links 130 for a given work area and be directed to the different scheduling programs for the other departments. Here the gas and electric departments will be aware of each other's dig in the same location and may be able to avoid duplicate work, by scheduling their respective jobs within quick succession of one another, thereby reducing overhead.

In a second instance, if the gas department schedules a service for a first manhole, and the electric department, using a separate program schedules a service for the same manhole on the same day, there would be no way to prevent physical work conflicts.

Thus, when a first department schedules a service on a given manhole, the link 130 to that scheduled service appears on the transparent layer 130. If a subsequent department then needs to schedule service on the same manhole they can simply consult the layered image 100 map of the street intersection and check the links 130 on the manhole which they need to service. If there is already a link 130 to another department's scheduling software they can open the link 130, check that schedule date and then set up their own service for a different date, adding a corresponding link 130.

Thus, without the need to integrate scheduling software, which is an expensive proposition, the utility company may use the present teachings to simply input their system maps, and allow different departments to add links 130 to avoid scheduling conflicts or otherwise coordinate scheduled work projects to reduce duplicate work.

In one embodiment of the present invention, another example of a use for system 10 is to dynamically track sensor data from data sources 24. For example, in a factory or plant valve status sensors can be used to provide updated information to dynamic data sources 24, such as pressure or flow rate. A user of system 10 may generate a layered image 100, by first recalling a primary image 110 such as a plant pipe blueprint. Next, using the process outlined above in steps 200-210, the user may drop links 130 on transparent layer 120 over each of the given valves on primary image 110. Here, link 130 is attached to the dynamic sensor data in data sources 24. Periodically, event module 90 of content rending module 50 may ping data source 24 for that link 130 for the update valve information (flow rate, etc.). This updated data can simply be attached to the link so that the data is fresh or, alternatively the icon representing link 130 may actually change shape, color, flash, or otherwise generate an alert should the sensor reading exceed some predetermined threshold. A similar arrangement may be useful using temperature sensor data in a utility company setting.

Yet another example of a use for system 10 is to dynamically track the location of an object from data sources 26. For example, in a warehouse or shipping yard setting, location monitors may be employed in certain objects such as shipping containers or crates. A user of system 10 may generate a layered image 100, by first recalling a primary image 110 such as a shipping yard map, or warehouse diagram. Next, using the process outlined above in steps 200-210, the user may drop links 130 on transparent layer 120 over each of the given objects on primary image 110. Here link 130 is attached to the location sensor data stored in data sources 26 for that particular object. Periodically, event module 90 of content rending module 50 may ping data source 26 updating the location of the object. As a result, the icon representing link 130 moves on transparent layer 120 registered over primary map or floor plan image 110. A similar arrangement may be used to track location of people (emergency personnel) or elevators vertically within a building.

With both examples, an original primary image 110 may be converted into a layered image 100 adding links 130, without the need to alter or reprocess the original primary image 110. This is particularly advantageous with blue print images or other drawing images that do not readily allow modification in the original form.

It is further contemplated that system 10 may be configured to dispose a transparent layer 120 over a primary image 110 creating a layered image 100 where the transparent layer 120 and links 130 thereon are generated over a first primary image 110, and then later re-scaled and viewed over a second primary image 110 that was not the original primary image used when generating the links. For example, in the case where two different departments from the same utility (e.g., electric and gas) each have a map of the same geographic area, typically they each generate their own layered image 100 over their own primary image 110 as stored in their data source 20. However, in the event that the first department (gas) would like to see certain links 130 (e.g., electric manholes) superimposed as a layered image 100 over their own gas department map primary image 110, system 10 may be configured to generate a layered image 100 by placing a transparent layer 120, originally created with electrical links 130 over an electric department map primary image 110, over the primary image 110 from the gas department, allowing them to view electric manhole links 130 on their own primary image 130 without the need to manually add all of those links 130 from the electric department data sources 20 in addition to their own gas links 130.

Similar viewings of transparent layers 120 generated over a first primary image 110 may be viewed over a second primary image 110 in other applications as well. In the case of intelligent primary images 110 (GIS, etc.) the transparent layer 120 can be refitted and registered using the embedded data in primary image 110. However, when primary image 110 is non-intelligent, viewing integration module 70 of system 10 may be required to either temporarily rescale the transparent layer 120 or the second primary image 110 so that the images may be appropriately registered to one another resulting in links 130 being disposed over their correct geographic location on the second primary image 110.

Thus, from the above description it can be seen that the uses for the present teachings are very broad. For example, the present teachings may be used in the fields of infrastructure, facility and asset management for homeland security and emergency response or simply to improve productivity, accuracy and decision support in the operations, maintenance and modification of such resources. The underlying primary document image 110 can be a map, floor plan, elevation, section, chart, workflow, photo, one-line diagram, or a schematic. Entities that own and/or manage such assets include:

Production and Processing Plants
1. Energy Generation (Nuclear, Fossil, Hydro)
2. Chemical and/or Pharmaceutical
3. Other Discrete and Process Manufacturing
4. Water Supply and Waste Water Treatment

Transmission, Distribution and Collection
1. Energy (Electricity, Gas, Steam)
2. Communications (Voice, Data, Etc.)
3. Water and Sewerage

Information Technology
1. Processing
2. Storage (e.g., data centers)
3. Networks

Transportation
1. Rail
2. Roads
3. Subways
4. Waterways
5. Air

Government
1. Civil
2. Military

Hospitals and Other Medical Facilities

Finance

Design Construction

Agriculture

Education
1. Universities
2. Research

Another example of a possible use for system 10 is in the manufacturing process for a particular product. For example, typical fabrication processes for a manufactured product are designated by a workflow, where each step relates to a certain process that may be handled by different departments/divisions within the plant. A user of system 10 may recall a high level work flow diagram as primary image 110 and then add links 130 on a registered transparent layer 120. Here, links 130 can be placed over the appropriate objects on primary image 110 such as over certain work stages in the work flow. Links 130 in this case would then link to either data such as exemplary images or instructional diagrams for that stage of the workflow or other executable programs that assist in a particular stage of the manufacturing process, each from various non-compatible data sources 20 within the company.

Yet another example of a possible use outside the field of commercial industrial use would be in the field of workflow management in the finance industry. Financial institutions frequently employ work flows that employ data and programs from various departments within a particular institution. However larger companies frequently have different IT structures between departments, making embedded and integrated work flow management difficult, costly and in some cases impossible. A user of system 10 may recall a high level work flow diagram as primary image 110 and then add links 130 on a registered transparent layer 120. Here, links 130 can be placed over the appropriate objects on primary image 110 such as over certain work stages in the work flow. Links 130 in this case would then link to either data or other programs on various non-compatible data sources 20 within the company.

Another example of a possible use for system 10 is in the context of buildings of a certain size and use, particularly in urban areas. The system 10 may provide fire related information to a fire department so that when rescue vehicles are responding to a fire, they can access critical information on floor plans (e.g., location of fire hoses, extinguishers, water pipes, hydrants, etc.) on tablets and/or other mobile devices.

It is understood that the above list is intended to be exemplary and that the present invention may also be applied to a wide range of other types of images and industries. For example, the underlying image can be a human body scan and links could be made from locations on the body to reports, test results and other information related to the specific locations on the patient's body, where ever these linked documents and data are located, within an organization or across the web.

The benefits of the present teachings are numerous. First, one does not need to work with the native file format of the primary image document 110 that is being overlain, so it becomes quite easy to work on top of any primary image 110 document type including raster scans of any image (text, charts, drawings, photos, schematics, etc.), computer aided design (CAD), 2D and 3D models (e.g., BIM model), geographic information system (GIS), word processing, spreadsheet, etc. files, as long as that image can be viewed by a third party viewing software product.

As noted above, standard Computer Aided Design and Geographic Information Systems typically require a vector rather than a raster format for drawings and maps to be used. In contrast, the present teachings work with any viewable document type regardless of the way the information is embedded in it (e.g. vector with ASCII text). The cost of converting raster documents into intelligent vector, word and spreadsheet documents is significant, so solutions that rely on such documents become prohibitively expensive to implement. In contrast, the present teachings are implemented quickly and with a much lower cost.

Also with the present teachings, links are made into multiple information sources including legacy information, making it possible to integrate various information sources without having to replace current systems and transform current information in the form of documents and data. Traditional integration solutions rely on replacement of current software applications with already integrated alternatives as in the case of Enterprise Resource Planning (ERP) solutions, or on very costly, time consuming integration code that must be written to get separate application software and associated data to work together. Rather, the present invention without that “tight” integration of traditional solutions, still provides a cost effective alternative solution.

While the present teachings have been described above in terms of particular embodiments, it is to be understood that they are not limited to those disclosed embodiments. Many variations and modifications will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings shown be determined by proper interpretation and construction of the appended claims and their legal equivalents, as understood by those of skill in the art relying upon the disclosure in this specification and the attached drawings.

What is claimed is:

1. A system for integrating a plurality of disparate data sources, each data source having a plurality of documents relating to built environments and/or natural environments, said system comprising:
a display configured to receive user input, which includes a user credential and a selection of a primary file that contains a plurality of objects, each object relating to a component of a built environment or a feature of a natural environment;
an interface apparatus configured to communicate with said display and the data sources, said interface apparatus having:
a content receiver configured to retrieve data from the data sources;
an overlay generator configured to generate a digital overlay document when said interface apparatus receives the selection of the primary file from said display, said digital overlay document comprising a transparent layer;
a link generator configured to generate a plurality of icons and insert said icons on said transparent layer of said digital overlay document, each icon linking to one or more documents which are contained in at least one of the data sources and related to one of the plurality of objects;
said overlay generator configured to, without modifying the primary file, superimpose said digital overlay document over the primary file and spatially register said digital overlay document to the primary file so that each icon superimposes over said one of the plurality of objects relating to the one or more documents that said icon links to, and so that said digital overlay document is separate from the primary file;
a security control unit configured to evaluate the user credential, in response to a subsequent selection of one of said icons by the user, to determine if the user is authorized to view the one or more documents which said user-selected icon links to;
wherein, upon said security control unit confirming authorization, said display subsequently presents the one or more documents which said user-selected icon links to.

2. The system of claim 1, wherein said security control unit evaluates the user credential to determine whether to connect said interface apparatus to said display in order to provide communication between said display and said interface apparatus.

3. The system of claim 1, wherein said security control unit communicates with an authentication authority of a respective entity managing the data source which contains the one or more documents which said user-selected icon links to, in order to confirm whether secured access to the one or more documents is to be granted to the user.

4. The system of claim 1, wherein said security control unit determines based on the user credential whether the user is authorized to view the one or more documents depending on a classification level of the one or more documents with the classification level defining a sensitivity of data contained in the one or more documents.

5. The system of claim 1, further comprising an overlay database which stores said digital overlay document with said plurality of icons, said overlay database being different from the plurality of disparate data sources.

6. The system of claim 1, wherein said interface apparatus includes an administration module which establishes a connection to said at least one of the data sources for importing the one or more documents which said user-selected icon links to, said administration module formatting the one or more documents before transmitting it to said content receiver.

7. The system of claim 1, wherein said display is a portable electronic device.

8. The system of claim 1, wherein the primary file comprises one of: a one-line diagram, a map, a blueprint, a floor plan, a building plan, a chart, a workflow, a 2D or 3D model, BIM model, an image, a computer aided drawing, schematic, slideshow file, text file, spreadsheet file, audio file, video file, or database file.

9. A system for integrating a plurality of disparate data sources, each data source having a plurality of documents relating to built environments and/or natural environments, the system comprising:
a display configured to receive user input, which includes a user credential and a selection of a primary file that contains a plurality of objects relating to components of a built environment and/or features of a natural environment;
an interface apparatus configured to communicate with said display and the data sources, said interface apparatus having:
a content receiver configured to retrieve data from the data sources;
an overlay generator configured to generate a digital overlay document when said interface apparatus receives the selection of the primary file from said display, said digital overlay document comprising a transparent layer;
a link generator configured to generate a plurality of data icons and insert said data icons on said transparent layer of said digital overlay document, each data icon links to one or more documents which are contained in at least one of the data sources and related to one of the plurality of objects;
said link generator being configured to generate a plurality of sensor icons and insert said sensor icons on said transparent layer of said digital overlay document, each sensor icon links to a sensor that provides data about one of the plurality of objects;
said overlay generator configured to, without modifying the primary file, superimpose said digital overlay document over the primary file and spatially register said digital overlay document to the primary file so that each data icon superimposes over said one of the plurality of objects relating to the one or more documents that said data icon links to, and so that each sensor icon superimposes over said one of the plurality of objects about which the sensor provides data;
wherein said digital overlay document is separate from the primary file;
wherein if one of said data icons is selected, said display presents the one or more documents which said user-selected data icon links to; and
wherein if one of said sensor icons is selected, said display presents the data which said user-selected sensor icon links to.

10. The system of claim 9, wherein the sensor comprises one of: a camera providing video of the one of the plurality of objects, an acoustic sensor, a vibration sensor, a chemical sensor, an electric sensor, an environmental sensor, a weather sensor, a flow sensor, a radiation sensor, an optical sensor, a pressure sensor, temperature sensor, or a GPS sensor.

11. The system of claim 9, wherein each sensor is assigned an internet protocol (IP) address;
wherein said system further comprises a sensor database storing the IP address of each sensor and a routing table which lists a plurality of communication routes to each sensor.

12. The system of claim 11, wherein, when one of said sensor icons is selected, said interface apparatus retrieves from said sensor database the IP address of the sensor which said user-selected sensor icon links to, and said interface apparatus uses the IP address to send a request signal for receiving real-time data from the sensor.

13. The system of claim 11, wherein said sensor database requests and polls data from each sensor at a pre-set interval, said sensor database storing the data to generate a historical record;
wherein, when one of said sensor icons is selected, said interface apparatus retrieves from said sensor database said historical record of the sensor which said user-selected icon links to, and said display presents said historical record.

14. The system of claim 9, wherein, when one of said sensor icons is selected, said interface apparatus connects with an external server in order to obtain the data which said user-selected sensor icon links to, the external server being controlled by an entity which manages the respective sensor and being configured to collect data from the respective sensor.

15. The system of claim 9, further comprising an event module that monitors the data sources for new and/or updated documents or new and/or updated data, said event module instructing said link generator to generate a notification marker in said data icons and said sensor icons when a new and/or updated document or new and/or updated data is present.

16. The system of claim 9, wherein the sensors associated with said plurality of sensor icons are arranged in one or more networks, each network being an Internet of Things (IoT),
wherein, when one of said sensor icons is selected, said interface apparatus connects directly to the IoT network that includes the sensor which said user-selected sensor icon links to, and
wherein said direct connection provides communication between said interface apparatus and the sensor which said user-selected sensor icon links to.

17. The system of claim 9, wherein the sensors associated with said plurality of sensor icons are arranged in one or more networks, each network being an Internet of Things (IoT), and
wherein said interface apparatus uses an application programming interface (API) to interact with an IoT management interface module of one of the IoT networks for providing communication with the sensors in the respective IoT network.

18. The system of claim 9, further comprising an equipment manager that monitors a status parameter of one of the components;
wherein said equipment manager transmits a signal indicating when said status parameter is outside a predetermined threshold.

19. The system of claim 18, wherein said signal indicates that said one of the components needs repair or replacement.

20. The system of claim 19, wherein said equipment manager determines whether repair or replacement of said one of the components is required based on at least one of a historical trend of said status parameter or a status parameter of another component.

21. A system for integrating a plurality of disparate data sources, each data source having a plurality of documents relating to built environments and/or natural environments, the system comprising:
a display configured to receive user input, which includes a user credential and a selection of a primary file that contains a plurality of objects, each object relating to a component of a built environment or a feature of a natural environment;
an interface apparatus configured to communicate with said display and the data sources, said interface apparatus having:
a content receiver configured to retrieve data from the data sources;
an overlay generator configured to generate a digital overlay document when said interface apparatus receives the selection of the primary file from said display, said digital overlay document comprising a transparent layer;
a link generator configured to generate a plurality of icons and insert said icons on said transparent layer of said digital overlay document, each icon linking to one or more documents which are contained in at least one of the data sources and related to one of the plurality of objects;
said overlay generator configured to, without modifying the primary file, superimpose said digital overlay document over the primary file and spatially register said digital overlay document to the primary file so that each icon superimposes over said one of the plurality of objects relating to the one or more documents that said icon links to, and so that said digital overlay document is separate from the primary file; and
an analyzer configured to scan the primary file for keywords, wherein for each keyword, said analyzer searches for documents within the plurality of disparate data sources related to the keyword, controls said link generator to automatically generate an icon for each document found, and inserts said icon on said transparent layer such that said icon superimposes over a location where the keyword appears in the primary file;
wherein if one of said icons is selected, said display presents the one or more documents which said user-selected icon links to.

22. The system of claim 21, wherein said analyzer analyzes the primary file for geo-coded data, said overlay generator being configured to relate said digital overlay document to the primary file based on the geo-coded data;
wherein said analyzer reviews the documents within the plurality of disparate data sources for location data; and
wherein for each document having location data, said link generator automatically generates an icon that links to the document and inserts said icon on said transparent layer based on the location data.

23. The system of claim 22, wherein said digital overlay document is related to the primary file by a coordinate system.

24. The system of claim 1, wherein the plurality of disparate data sources and/or document sources are managed by different entities, each entity having its own authentication authority;
wherein the security control unit communicates with the authentication authority of the respective entity managing the data source which contains the one or more documents which the user-selected icon links to, in order to confirm whether secured access to the one or more documents is to be granted to the user; and
wherein if the security control unit determines that the user is not authorized to view the one or more documents, the security control unit transmits a warning signal to the authentication authority of the respective entity managing the data source which contains the one or more documents.

25. The system of claim 1, wherein the selection of the primary file is performed automatically by the interface apparatus based on the user credential.
